(19) United States
(12) Patent Application Publication
(10) Pub. No.: US 2006/0120335 A1
(43) Pub. Date: Jun. 8, 2006

(54) Wireless LAN transmitter and receiver for audio equipment and method thereof for transmissions

(75) Inventors: Ching-Fu Teng, Hsinchu (TW); Yi-Chang Tsai, Hsinchu (TW)

Correspondence Address: BIRCH STEWART KOLASCH & BIRCH, PO BOX 747, FALLS CHURCH, VA, 22040-0747, US

(73) Assignee: Z-Com, Inc.

(21) Appl. No.: 11/088,780

(22) Filed: Mar. 25, 2005

(30) Foreign Application Priority Data
Dec. 8, 2004 (TW) 93138026

(51) Int. Cl. H04Q 7/24

(52) U.S. Cl. 370/338

(57) ABSTRACT

A wireless LAN transmitter/receiver is provided for transmitting a signal to a wireless LAN receiver through a channel. The transmitter/receiver includes: an input device having an interface for a user to input an identification value; an identification value coder/decoder for encoding/decoding the identification value in the signal as a basis for connecting with the wireless LAN transmitter/receiver; and an D/A converter for converting the signal from the identification value coder/decoder into an analog signal for transmitting through the channel later.

### BACKGROUND OF THE INVENTION

1. Field of Invention

The invention relates to a wireless local area network (LAN) transmitter/receiver module and the method of establishing wireless network transmissions. In particular, the invention relates to a wireless LAN transmitter/receiver for audio equipment and the method of establishing wireless network transmissions.

2. Related Art

With rapid advance in the network technology and continuous increase in the connection speed, the network has become an indispensable part of our life. The breakthrough and convenience in the wireless network communications technology and the decreasing price of related products have brought us the wireless LAN transmitter/receiver modules in place of conventional wired networks.

Take the BSS (Basic Service Set) or ESS (Extended BSS) wireless network transmission structure as an example, several computers or data processing devices installed with wireless LAN transmitter/receiver modules have to use software to initiate wireless LAN transmissions in order to transfer data. This process includes the steps of identifying the MAC address and service setting identification (SSID). After identifying the SSID, the devices are then able to use the wireless network to transmit data.

For devices that want to take advantage of the wireless network transmission technology, such as the audio player and speakers in audio/video (AV) equipment, using software to set up transmissions cannot directly set data transfers between two parties. It is inflexible for users. For example, currently users can only accept the default settings of the products: speaker A receives only the audio signal from player A, and speaker B receives only the audio signal from player B. One cannot control speaker B to receive the audio signal from player A according to his/her will.

On the other hand, the conventional procedure of establishing wireless LAN transmissions for multiple wireless LAN transmitters to multiple wireless LAN receivers creates difficulties and troubles for the user to set paired connections.

Moreover, users may not be able to tell the paired audio players and speakers from their appearance.

Therefore, for those devices that make use of the wireless LAN transmission technology, such as the audio equipment, how to easily establish the wireless LAN transmissions and how to tell from their appearance which one should be paired up for single-to-multiple or multiple-to-multiple network transmissions to increase their versatility are important problems to be solved.

### SUMMARY OF THE INVENTION

In view of the foregoing, an objective of the invention is to provide a wireless LAN transmitter/receiver that is different from the conventional devices that can only use software to establish wireless transmissions. The invention contains an exposed hardware module that allows the user to manually control the party paired with the wireless LAN transmitter/receiver.

Another objective of the invention is to provide an audio player and speakers built in with the wireless LAN transmitter/receiver so that the audio player does not need to use software to establish wireless transmissions with the speakers. The user can readily assemble the wireless LAN transmissions.

A further objective of the invention is to provide a method of establishing wireless connections. The user uses the exposed hardware module to manually enter an identification value. The wireless LAN transmitter and the wireless LAN receiver with the same identification value are paired together for data transmissions.

According to the above objectives, the disclosed wireless LAN transmitter uses a wireless transmission channel to send a signal to a wireless LAN receiver. It contains an input device having an exposed interface for a user to enter an identification value; an identification value coder/decoder for encoding/decoding the identification value in the signal as a means for connecting with the wireless LAN receiver/transmitter; and an digital/analog (D/A) converter for converting the signal from the identification value coder/decoder into an analog signal for transmitting through the channel later.

To achieve the above objectives, the wireless LAN receiver of the invention generates a response signal according to a connection request signal sent by the wireless LAN transmitter via a wireless transmission channel. The wireless LAN receiver includes: an input device having an exposed interface for a user to enter an identification value; and an identification value coder/decoder for encoding/decoding the identification value in the response signal as a means for connecting with the wireless LAN transmitter.

To achieve the above objectives, an audio player built in with the wireless LAN transmitter according to the invention sends a music signal via a wireless transmission channel to a speaker built in with the wireless LAN receiver. The audio player includes: an audio processing module for generating the music signal; a wireless processor for controlling the transmission of the music signal following a wireless communication protocol over the wireless transmission channel; an input device having an exposed interface for a user to enter an identification value; an identification value coder/decoder for encoding/decoding the identification value in the music signal as a means for connecting with the speaker; and an D/A converter for converting the signal from the identification value coder/decoder into an analog signal for transmitting through the channel later.

To achieve the above objectives, a player built in with the wireless LAN transmitter according to the invention sends a music signal via a wireless transmission channel to a speaker built in with the wireless LAN receiver. The speaker includes: a wireless processor for generating a response signal according to the connecting request signal and sending the response signal following a wireless communication protocol over the wireless transmission channel; an input device having an exposed interface for a user to enter an identification value; and an identification value coder/decoder for encoding/decoding the identification value in the music signal as a means for connecting with the speaker.

The interface mentioned above can be a DIP switch, a keypad, a touch-control panel or another other interface with similar functions.

It should be noted that the transmitter and the receiver described above are all can be replaced by a transceiver having both functions of the two.

To achieve the above objectives, the disclosed method of establishing wireless connections is used in an audio system, in which the audio player built in with a wireless LAN transmitter can establish connections with more than one speaker built in with the wireless LAN receiver. The method includes the steps of: sending a request for identification values to all the wireless LAN receivers via a wireless transmission channel; comparing all the received identification values with its own identification value; and establishing connections with those wireless LAN transmitters with the same identification value.

Before the step of sending a request for identification values to all the wireless LAN receivers via a wireless transmission channel, the method can further include the step of scanning all the available wireless transmission channels in order to select one to use. If no available or clean channel is found, one channel will be randomly selected. Otherwise, a clean or available channel is selected.

The clean channel described above can be a channel without or having little interference or a channel that no one uses.

When the wireless LAN receiver receives the identification value request, it sends out a response signal containing its identification value for comparison.

Moreover, the transmitted music signal after the connection is established always contains the identification value of the wireless LAN transmitter for identification purposes.

Using the invention, the user can manually select wireless LAN transmitters to be paired without using any software. Therefore, the invention provides a more versatile and simpler method to establish wireless connections in a single-to-multiple or multiple-to-multiple system.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the disclosed AV system using wireless LAN transmitter/receiver according to a preferred embodiment of the invention;

FIG. 2 is a schematic view showing details of FIG. 1;

FIG. 3 is a preferred embodiment of possible variations of a 4-bit identification value;

FIG. 4 is a flowchart of establishing a connection for the disclosed wireless LAN transmitter;

FIG. 5 is a flowchart of establishing a connection for the disclosed wireless LAN receiver;

FIG. 6 is a flowchart of sending a signal from the disclosed wireless LAN transmitter; and

FIG. 7 is a flowchart of receiving a signal at the disclosed wireless LAN receiver.

### DETAILED DESCRIPTION OF THE INVENTION

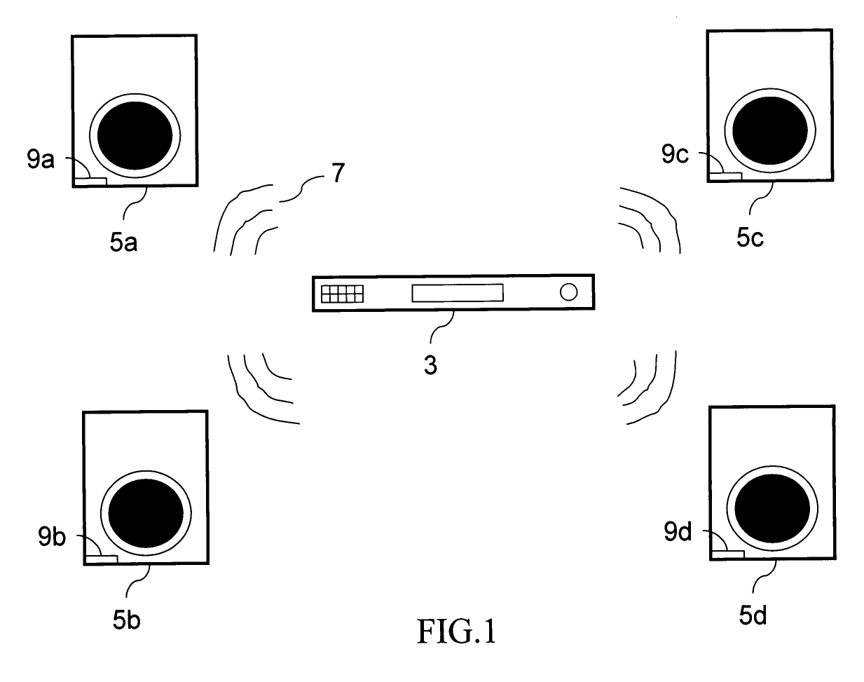

With reference to FIG. 1, a normal audio system includes an audio player 3, such as a CD/DVD player, and several speakers 5a, 5b, 5c, 5d for receiving signals and making sounds. The audio system using the invention is characterized in that the audio player 3 and the speakers 5a, 5b, 5c, 5d transmit data via a wireless network 7. The way they establish wireless connections is different from the prior art. Using the disclosed hardware design, a user can manually enter an identification value for each of the devices using the exposed hardware input modules 9a, 9b, 9c, 9d. The player 3 and the speakers 5a, 5b, 5c, 5d entered with the same identification value can readily establish wireless LAN connections without software settings. It achieves the transmissions in a single-to-multiple system.

If two or more audio players exist in an environment, one can utilize the hardware design for inputting identification values on the devices to distinguish at least two sets of audio player and associated speakers with different identification values. The two sets will not interfere with each other. It thus achieves the transmissions in a multiple-to-multiple system.

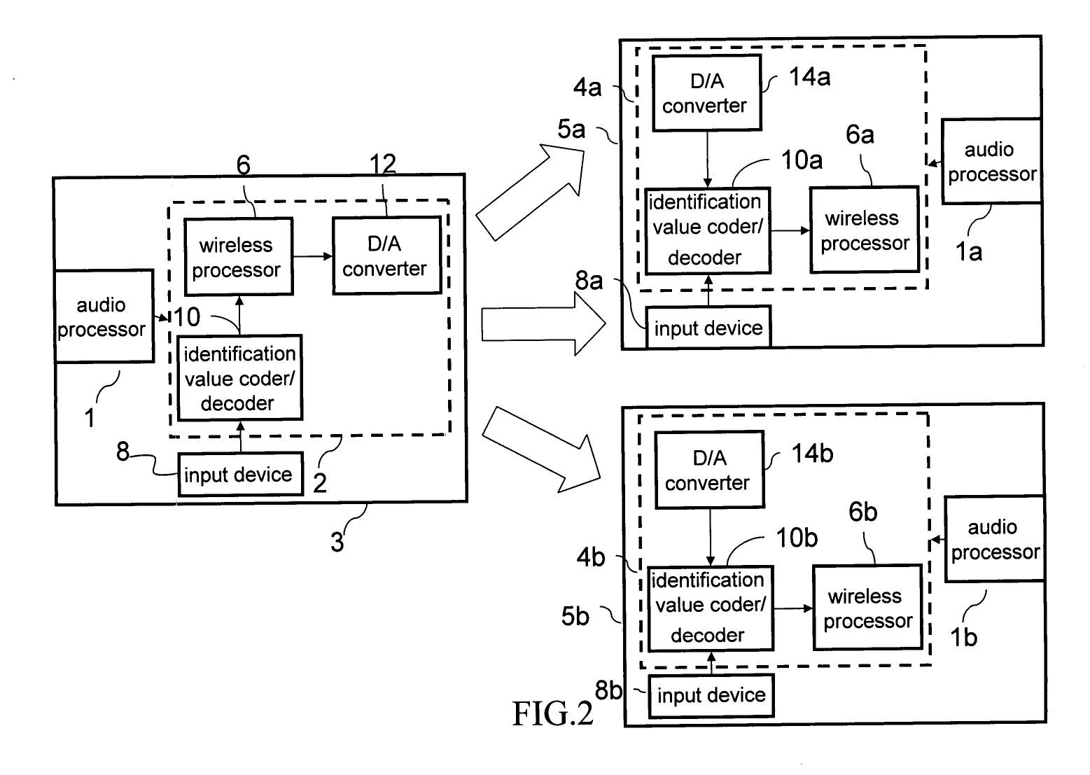

In the following, we explain in detail the composition of the disclosed wireless LAN transmitter/receiver. With reference to FIG. 2, the audio system contains at least an audio player 3 which is built in with the wireless LAN transmitter and two speakers 5a, 5b built in with the wireless LAN receiver in the same environment. In this embodiment, we use one audio player 3 and two speakers Sa, 5b as an example. Since the audio player 3 and the two speakers 5a, 5b use the disclosed wireless LAN transmitter/receiver 2, 4a, 4b, they can establish a wireless connection for data transmissions.

The audio player 3 contains an audio processor 1 and a wireless LAN transmitter 2.

The audio processor 1 generates an audio signal according to digital music data, which come from an optical storage medium such as a CD or DVD, or directly from a storage device.

The wireless LAN transmitter 2 contains an input device 8, an identification value coder/decoder 10, a wireless processor 6, and a D/A converter 12. It is featured in the input device 8 and the connected identification value coder/decoder 10. The user can manually set the identification values of the transmitter and the receiver. Therefore, the transmitter and receivers with the same identification value can communicate wirelessly.

We explain in the following each module in the wireless LAN transmitter 2. The input device 8 has an exposed interface built outside the wireless LAN transmitter for a user to enter an identification value. The interface can be a DIP switch, a keypad, a touch-control panel or any other interface with similar functions. Therefore, by manipulating the input device 8, the user can enter various combinations of numbers and text. After receiving the identification value from the input device 8, the identification value coder/decoder 10 encodes it in the signal to be sent by the wireless processor 6. Therefore, the signal being sent includes the identification value of the transmitter, and only the transmitters with the same identification value can establish connections.

The wireless processor 6 sends a request for establishing connections with the wireless LAN receiver 4a, 4b. As well known, it can control the power, control or generate a signal, control encoding, and modulate the MAC utilities. Therefore, once the transmitted signal contains the identification value, it can be controlled to travel according to a wireless network communication protocol along a wireless transmission channel. Only the receivers with the same identification value are allowed to establish connections.

The wireless network communication protocol can be the 802.11x series. The identification value is added to the end of the MAC address in the wireless network communication protocol.

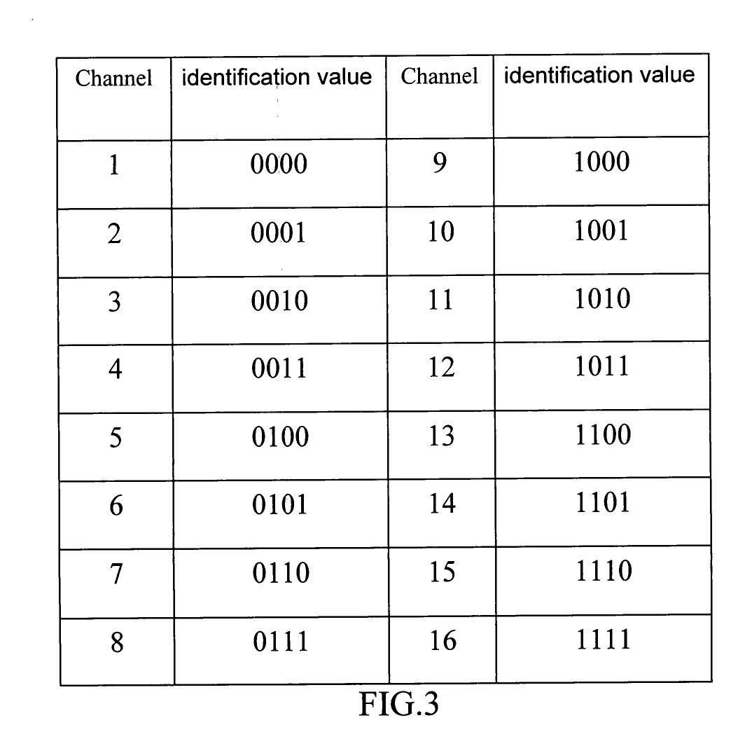

As shown in FIG. 3, the identification value is a 4-bit identification value according to a preferred embodiment of the invention.

As shown in the drawing, for a 4-bit identification value, the input device 8 can be a 4-digit DIP switch. For binary signal input, there are totally 16 possibilities. For example, as long as a speaker is set as 0000 as the DIP switch of the audio player, it can directly establish a connection for data transmissions with the audio player.

According to the request of the wireless LAN transmitter, the D/A converter 12 can convert the digital signal provided by the wireless processor 6 to an analog signal for subsequent transmissions via a channel of an antenna.

On the other hand, the speakers 5a, 5b generate a response signal for the connection request signal sent from the audio player 3 via the wireless transmission channel to provide its identification value as a means for establishing a wireless connection with the wireless LAN transmitter.

The speakers 5a, 5b also contain audio processors 1a, 1b and wireless LAN receivers 4a, 4b. The wireless LAN receiver 4a, 4b contain respectively wireless processors 6a, 6b, input devices 8a, 8b, identification value coder/decoder 10a, 10b, and D/A converters 14a, 14b.

Each of the wireless processors 6a, 6b is used to generate a response signal according to the connection request and sends the response signal via the wireless transmission channel according to a wireless network communication protocol.

Likewise, each of the input devices 8a, 8b has an exposed interface for the user to enter an identification value.

Each of the identification coder/decoder 10a, 10b encodes the identification value in the response signal as a means to establishing a wireless connection.

Each of the D/A converters 14a, 14b converts the received signal via the wireless transmission channel into a digital signal for subsequent processing.

It should be noted that although the drawing does not show the details of the exposed interfaces of the input devices 8, 8a, 8b, 9a, 9b, 9c, 9d. In practice, the input device has to be exposed so that the user can directly enter the identification value for settings.

It also should be noted that the transmitter and the receiver described above are all can be replaced by a transceiver having both functions of the two.

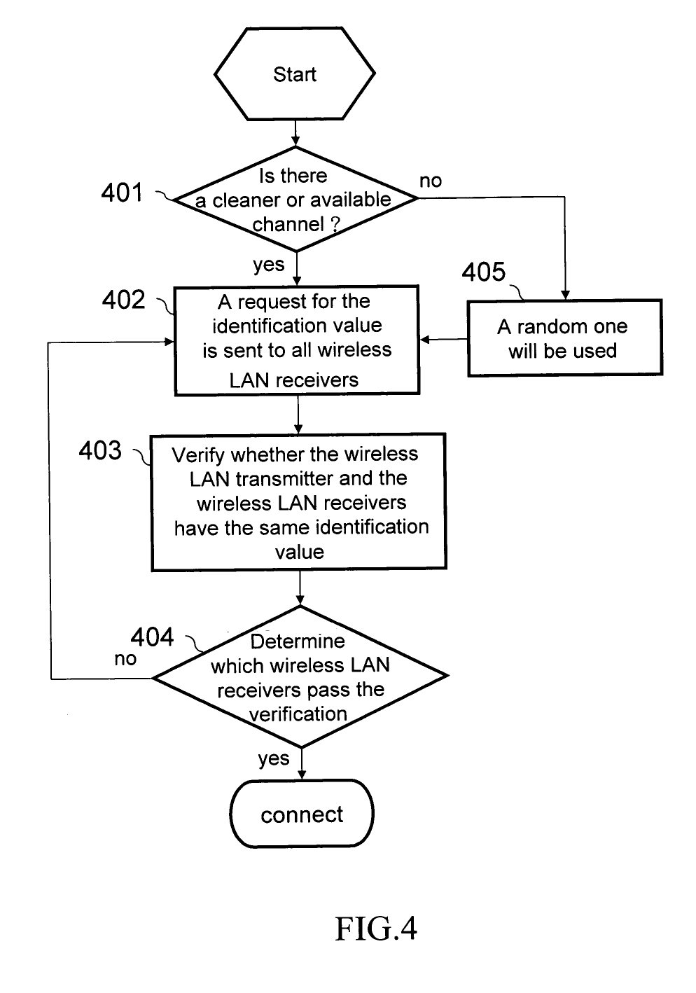

FIG. 4 gives a flowchart of establishing a connection using a wireless LAN transmitter according to a preferred embodiment of the invention.

Once the power is turned on, all channels (e.g. channels 1˜11) are scanned to look for cleaner or available ones (step 401). After a channel is found, a request for the identification value is sent to all wireless LAN receivers (step 402). After receiving the identification values of the wireless LAN transmitters, it is verified whether the wireless LAN transmitter and the wireless LAN receivers have the same identification value (step 403). The wireless LAN receivers passing the verification establish connections with the wireless transmitter (step 404). If no clean channel is available, a random one will be used (step 405). Afterwards, step 402 and later steps are repeated. If the verification fails, the procedure also goes back to step 402.

The clean channel described above can be a channel without or having little interference or a channel that no one uses.

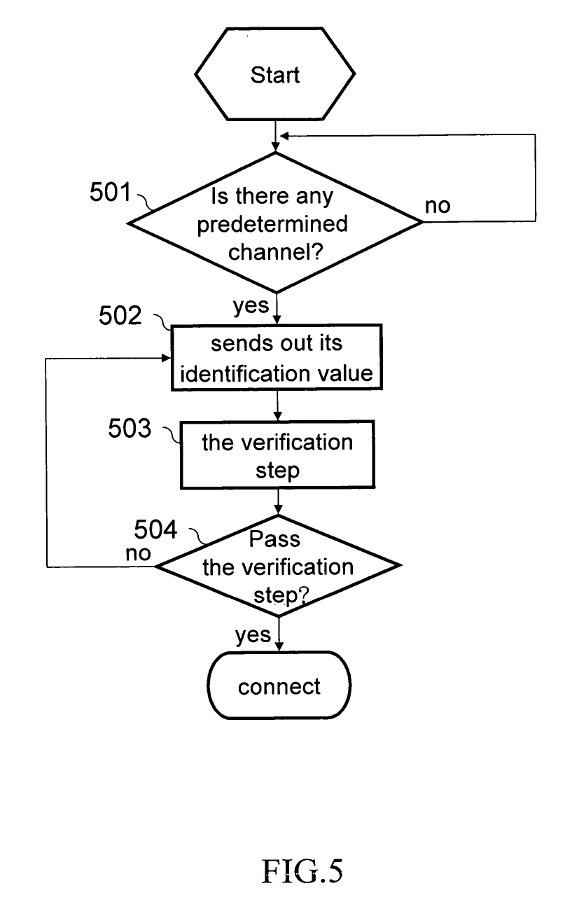

FIG. 5 gives a flowchart of establishing a connection using a wireless LAN receiver according to a preferred embodiment of the invention.

Once the power is turned on, the system scans for a predetermined channel (step 501). Once the channel is found, it sends out its identification value (step 502) to verify with the wireless LAN transmitters. During the verification step, the wireless LAN transmitter and the wireless LAN receiver compare their identification values (step 503). The system checks whether the verification is all right (step 504). The verified wireless LAN receiver then establishes a connection with the wireless LAN transmitter. Otherwise, the procedure goes back to step 502.

The preferred embodiments shown in FIGS. 4 and 5 employ passive verification on the wireless LAN receiver. In practice, one may choose active verification too.

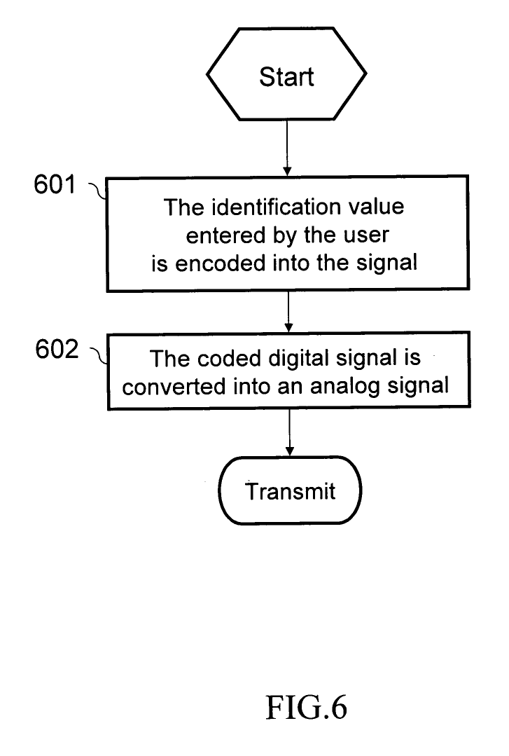

FIG. 6 shows a flowchart of sending a signal from the wireless LAN transmitter according to a preferred embodiment of the invention.

After the signal to be transmitted has been processed, the identification value entered by the user is encoded into the signal (step 601). The coded digital signal is converted into an analog signal (step 602), which is then sent out through a channel via an antenna.

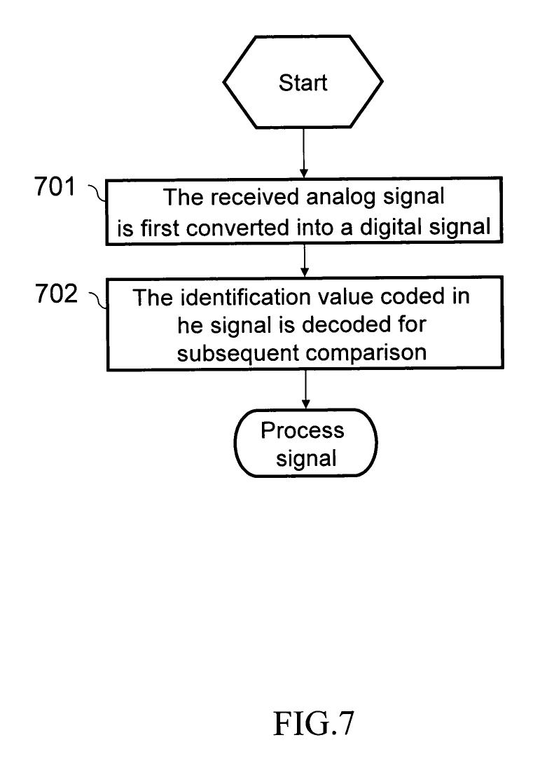

With reference to FIG. 7, according to a preferred embodiment of processing the received signal at the wireless LAN receiver, the received analog signal is first converted into a digital signal (step 701). The identification value coded in the signal is decoded for subsequent comparison (step 702).

Certain variations would be apparent to those skilled in the art, which variations are considered within the spirit and scope of the claimed invention.

What is claimed is:

1. A wireless local area network (LAN) transmitter for sending a signal via a wireless transmission channel to a wireless LAN receiver, comprising:
an input device, which has an interface for a user to enter an identification value;
an identification value coder/decoder, which encodes the identification value in the signal as a means to establish a wireless connection with the wireless LAN transmitter; and
a digital-to-analog (D/A) converter, which converts the signal provided by the identification value coder/decoder into an analog signal for subsequent transmissions over the wireless transmission channel.

2. The wireless LAN transmitter of claim 1, wherein the interface is a DIP switch.

3. The wireless LAN transmitter of claim 1, wherein the interface is a touch-control panel.

4. The wireless LAN transmitter of claim 1 further comprising a wireless processor to control the transmission of the analog signal according to a wireless network communication protocol.

5. A wireless LAN receiver for generating a response signal according to a connection request command sent by a wireless LAN transmitter through a wireless transmission channel, comprising:
an input device, which has an interface for a user to enter an identification value; and
an identification value coder/decoder, which encodes the identification value in the response signal as a means for the wireless LAN transmitter to establish a wireless connection.

6. The wireless LAN receiver of claim 5, wherein the interface is a DIP switch.

7. The wireless LAN receiver of claim 5, wherein the interface is a touch-control panel.

8. The wireless LAN receiver of claim 5 further comprising a wireless processor to control the transmission of the analog signal according to a wireless network communication protocol.

9. An audio player built in with a wireless LAN transmitter for sending a music signal through a wireless transmission channel to a speaker built in with a wireless LAN receiver, comprising:
an audio processing module, which generates the music signal;
a wireless processor, which controls the transmission of the music signal through the wireless transmission channel according to a wireless network communication protocol;
an input device, which has an interface exposed on the audio player for a user to enter an identification value;
an identification value coder/decoder, which encodes the identification value in the music signal as a means for establishing a wireless connection with the speaker; and
a D/A converter, which converts the signal provided by the identification value coder/decoder into an analog signal for subsequent transmissions over the wireless transmission channel.

10. The audio player built in with a wireless LAN transmitter of claim 9, wherein the interface is a DIP switch.

11. The audio player built in with a wireless LAN transmitter of claim 9, wherein the interface is a touch-control panel.

12. An speaker built in with a wireless LAN receiver for receiving a connection request command through a wireless transmission channel from an audio player built in with a wireless LAN transmitter, comprising:
a wireless processor, which generates a response signal according to the connection request command and sends the response signal through the wireless transmission channel according to a wireless network communication protocol;
an input device, which has an interface exposed on the speaker for a user to enter an identification value; and
an identification value coder/decoder, which encodes the identification value in the response signal as a means for establishing a wireless connection with the audio player.

13. The speaker built in with a wireless LAN receiver of claim 12, wherein the interface is a DIP switch.

14. The speaker built in with a wireless LAN receiver of claim 12, wherein the interface is a touch-control panel.

15. A method of establishing wireless connections in an audio system for an audio player built in with a wireless LAN transmitter to connect with a plurality of speakers built in with wireless LAN receivers, the method comprising the steps of:
sending a request for identification values to all wireless LAN receivers via a wireless transmission channel;
comparing all received identification values with its own identification value; and
establishing connections with those wireless LAN receivers with the same identification value.

16. The method of claim 15, wherein the step of sending a request for identification values to all wireless LAN receivers via a wireless transmission channel is proceeded by the step of scanning all wireless transmission channels to select one.

17. The method of claim 16, wherein the step of scanning all wireless transmission channels to select one includes the step of scanning all wireless transmission channels and randomly finding one wireless transmission channel among them when no wireless transmission channel is available.

18. The method of claim 16, wherein the step of scanning all wireless transmission channels to select one includes the step of scanning all wireless transmission channels and selecting one wireless transmission channel that is available.

19. The method of claim 15, wherein the step of sending a request for identification values to all wireless LAN receivers via a wireless transmission channel is flowed by the step of sending an identification value from the wireless LAN receiver to the wireless LAN transmitter via the wireless transmission channel.

20. The method of claim 15, wherein the step of comparing all received identification values with its own identification value is followed by the step of sending a music signal to all the wireless LAN receivers via the wireless transmission channel.

21. The method of claim 20, wherein the music signal contains the identification value of the wireless LAN transmitter.
